(19) United States
(12) Patent Application Publication
(10) Pub. No.: US 2003/0028429 A1
(43) Pub. Date: Feb. 6, 2003

(54) Media purchase goal correlation system

(76) Inventors: Gary Mittman, Venice, CA (US); Ethan Joffe, Venice, CA (US)

Correspondence Address: DAVID A. BELASCO, ESQ., BEEHLER & PAVITT, Suite 330, 100 Corporate Pointe, Culver City, CA, 90230, US

(21) Appl. No.: 09/922,425

(22) Filed: Aug. 3, 2001

(51) Int. Cl. G06F 17/60; G06F 7/00; G06F 17/00

(52) U.S. Cl. 705/14; 707/104.1

(57) ABSTRACT

A media purchase goal correlation system includes a variety of advertising media purchases. Each media purchase relates to a predetermined subject matter and is placed in movies, video, television, interactive television, radio or print media within a stated geographic area. The media purchase includes either an Internet website address or other unique trackable identifier for accessing further information related to the subject matter of the media purchase. A first database contains records relating to the start date, end date, and stated geographic area for the media purchases. Means are provided for determining the geographic location associated with Internet Protocol addresses and for grouping the geographic locations into uniform stated geographic areas. A second database contains records correlating Internet Protocol addresses of Internet users with stated geographic areas. Means are provided for determining the Internet Protocol address of an Internet user accessing the Internet website address, for tracking the timing of Internet-related goals achieved by the Internet user related to his accessing the Internet website address and for accessing the second database and assigning a stated geographic area to the user's Internet-related goals. Means are provided for inputting the timing of occurrences of the Internet-related goals and assigned stated geographic area to the first database, for correlating and reporting the timing of Internet-related goals achieved by the Internet user with the start date, end date and a residual period for media purchases within the stated geographic area. A variety of graphical and tabular reports are available to illustrate the correlation.

### FIELD OF INVENTION

The invention pertains to determining the relative value of media purchases. More particularly, the invention relates to methods for determining a correlation between a media purchase and stated world-wide network-related goals.

### BACKGROUND OF THE INVENTION

Various systems have been developed for correlating advertising media purchases with product sales or other stated goals. U.S. Pat. No. 6,243,750 issued to Verma is directed toward a method and system for measuring web site access requests. The referenced web page requested is sent to a user system and rendered through a web browser where an appended identifying tag is removed. Using the striped off tag, an application running on the advertiser's web server determines if the tag has already been assigned a corresponding counter. When a counter corresponding to the tag has been assigned, the server application increments the number of “hits” shown in the counter. On the other hand, if a counter corresponding to the tag has not been assigned, the server application creates a corresponding counter and sets the counter value to one.

U.S. Pat. No. 6,223,215 issued to Hunt et al., is directed towards tracking a user's purchases on the Internet by associating the user with an inbound source and session identifier. The operation begins in response to a new user initiating access to an interactive network site. A unique session ID is assigned from a front-end session database, and relevant user data is recorded in the session database associated with the session ID. For example, the relevant user data includes the user's inbound source “origin” such as a unique source ID of a banner “advertisement” on a search engine Internet site.

U.S. Pat. No. 5,227,874, issued to Von Kohorn is directed towards a method for measuring the effectiveness of stimuli on decisions of shoppers. Two signals are broadcast by a central station to each of two receiving stations. One of these two signals is a program signal for presenting on a television screen a program generated in the studio. The second of the two signals is an instructional or command signal for operation of a response unit. The instructional signal provides appropriate commands to the response unit for evaluating, rejecting, or accepting and scoring audience responses to questions raised in the televised program. In both of the receiving stations the response unit includes a keyboard whereby a person in the remote viewing audience enters a response. The response unit includes a dispenser that dispenses a record of score and/or responses in a permanent recording medium such as a card of plastic or similar material, including a strip of magnetizable material upon which the score and/or responses have been recorded.

U.S. Pat. No. 6,006,197 issued to D'Eon et al. is directed toward a system and method for assessing effectiveness of Internet marketing campaigns. A PC can access one or more sites that can present one or more banner advertisements. When one of the advertisements is clicked on by a user to, for example, hyperlink to the site of the advertiser represented by the advertisement, tracker software unobtrusively tracks the user around the advertiser's site. The advertisement identification, although being ignored as part of an actual network path, is buffered and then correlated with the visitor identification. The tracker module records the identifications of users, as represented by the visitor identifications, who click on the advertisements. Each time a user clicks on one of the advertisements, an “impression” of the clicked-on advertisement by visitor identification is thereby established and recorded.

U.S. Pat. No. 5,948,061 issued to Merriman et al. is directed towards a method of delivery, targeting and measuring advertising over networks. As part of the “click through” process, when the user clicks on the banner or other advertising object displayed by the user's browser, the user's browser transmits a message to the ad server. The ad server notes the address of the computer of the browser (or any other identifier such as a cookie or a digital signature) that generated the message and transmits back the URL of the advertiser's web page so that the user's web browser generates a message to contact the advertiser's web site. The ad server process notes that a “click-through” for an advertisement has occurred and updates various databases. While other variations exist, the above-described designs for systems for correlating advertising media purchases with product sales or other stated goals are typical of those encountered in the prior art.

It is an objective of the present invention to provide a means for purchasers of non-Internet related advertising media to correlate these purchases to stated goals related to Internet activity. Such goals include online sales, downloads, arrivals at specified web addresses, user data capture, sales lead generation, identification of dealer locations, viewing of specific text, viewing of specific images and receiving sound transmissions. Non-Internet related media include movies, video, television, interactive television, radio and print media. It is a further objective to provide such correlation for media purchases in non-Internet related media made within a stated geographic area. It is a still further objective of the invention to provide the above described correlation and related statistical analysis relating the period of the media purchase to the occurrence of the stated goals within the period and an identified “residual” period. It is yet a further objective to provide graphical and tabular statistical analysis tools for analyzing and displaying the correlations determined between the media purchases and the achieved goals.

While some of the objectives of the present invention are disclosed in the prior art, none of the inventions found include all of the requirements identified.

### SUMMARY OF THE INVENTION

The present invention addresses most of the deficiencies of prior art media purchase goal correlation system inventions and satisfies all of the objectives described above. A media purchase goal correlation system providing the desired features may be constructed from the following components. An advertising media purchase is provided. The media purchase relates to a predetermined subject matter and is placed in movies, video, television, interactive television, radio or print media within a stated geographic area. The media purchase includes either an Internet website address or other unique trackable identifier for accessing further information related to the subject matter of the media purchase.

A first database is provided. The first database contains records relating to the start date, end date, and stated geographic area for a plurality of media purchases. Means are provided for inputting and maintaining records in the first database. Means are provided for determining the geographic location associated with an Internet Protocol address. Means are provided for grouping the geographic locations into uniform stated geographic areas.

A second database is provided. The second database contains records correlating Internet Protocol addresses of Internet users with stated geographic areas. Means are provided for inputting and maintaining records in the second database. Means are provided for determining the Internet Protocol address of an Internet user accessing the Internet website address. Means are provided for tracking the timing of Internet-related goals achieved by the Internet user related to his accessing the Internet website address. Means are provided for accessing the second database and assigning a stated geographic area to the user's Internet-related goals.

Means are provided for inputting the timing of occurrences of the Internet-related goals and assigned stated geographic area to the first database. Means are provided for correlating and reporting the timing of Internet-related goals achieved by the Internet user with the start date, end date and a residual period for media purchases within the stated geographic area.

In a variant of the invention, a media purchase effectiveness report is provided. The effectiveness report includes a media type, media name, stated geographic area of the media purchase, start date, end date, summary of Internet traffic originating in the stated geographic area between the start and end dates, and summary of Internet-related goals achieved for Internet users located within the stated geographic area between the start and end dates and during the residual period. The media purchase effectiveness report will permit a media buyer to correlate volume of Internet traffic and related goal achievement resulting from a media purchase in a stated geographic area.

In another variant, the media effectiveness report is compiled continuously from the start date to the end date of the media purchase and for the residual period and is made available through the Internet, whereby a media buyer may evaluate the initial and residual Internet-related impact of any media purchase.

In still another variant, the Internet-related goals comprise sales, downloads, arrivals at specified web addresses, user data capture, sales lead generation, identification of dealer locations, viewing of specific text, viewing of specific images and receiving sound transmissions.

In a further variant of the invention, the means for correlating and reporting the timing of Internet-related goals achieved by an Internet user with the start date, end date and a residual period for media purchases within the stated geographic area includes graphical representations of media purchases for specified periods for stated geographical areas. It further includes graphical representations of timed occurrences of media goals achieved in the stated geographical areas, and graphical representations of the correlation of the timed occurrences of media goals with the media purchase periods for the areas.

In another variant, the means for correlating and reporting the timing of Internet-related goals achieved by an Internet user with the start date, end date and a residual period for media purchases within the stated geographic area includes pattern recognition systems for analyzing data yielding the graphical representations to produce a media purchase decision.

In still another variant, the means for correlating and reporting the timing of Internet-related goals achieved by an Internet user with the start date, end date and a residual period for media purchases within the stated geographic area includes baseline statistical reports of media goals achieved absent media purchases, statistical reports detailing media goals achieved after media purchases, and reports comparing baseline statistics to those resulting from media purchases in stated geographical areas.

In yet another variant of the invention, the means for correlating and reporting the timing of Internet-related goals achieved by an Internet user with the start date, end date and a residual period for media purchases within the stated geographic area includes historical reports detailing effectiveness of media purchases in stated geographical areas and means for comparing the historical reports to current media goal achievement reports to determine a differential effect of new media purchases. Such comparisons are useful for predicting the effect of future media purchases.

Additional tabular reports, illustrating unique Internet user visits to an Internet web site, related sales and a percentage showing the conversion of the visits to sales for identified media purchasers, in stated geographic areas over various time periods are also provided.

An appreciation of the other aims and objectives of the present invention and an understanding of it may be achieved by referring to the accompanying drawings and the detailed description of a preferred embodiment.

### DESCRIPTION OF THE DRAWINGS

FIG. 1 is a schematic illustration of media purchases, a first database containing media purchase and goal achievement data and means for updating the database;

FIG. 2 is a schematic illustration of a means for determining a geographic location associated with an Internet Protocol address;

FIG. 3 is a schematic illustration of a means for grouping geographic locations into uniform stated geographic areas;

FIG. is a schematic illustration of a second database containing data identifying stated geographic areas for Internet Protocol addresses and means for updating the database;

FIG. 5 is a schematic illustration of a means for tracking the timing of Internet-related goals achieved by an Internet user related to his accessing of an Internet web site;

FIG. 6 is a schematic illustration of a media purchase effectiveness report;

FIG. 7 is a schematic illustration of a means for accessing the FIG. 6 report over the Internet;

FIG. 8 is a schematic illustration of a graphical representation of media purchases for a stated time period;

FIG. 9 is a schematic illustration of a graphical representation of media goals achieved for a stated time period;

FIG. 10 is a schematic illustration of a graphical representation of a correlation of media goals achieved with purchases for a stated time period;

FIG. 11 is a schematic illustration of a baseline report for media goals achieved without a media purchase over a stated period;

FIG. 12 is a schematic illustration of a report for media goals achieved with a media purchase over a stated period;

FIG. 13 is a schematic illustration of a report detailing percent change between the baseline period and subsequent period with media purchase;

FIG. 14 is a schematic illustration of a historical media purchase effectiveness report;

FIG. 15 is a schematic illustration of a report comparing the historical period with a period including media purchases showing percentage and ratio of changes in media goals achieved;

FIG. 16 is a schematic illustration of use of a pattern recognition system to develop media purchase decisions;

FIG. 17 is a schematic illustration of a tabular report illustrating unique Internet user visits to an Internet web site, related sales and a percentage showing the conversion of the visits to sales for a media purchaser;

FIG. 18 is a schematic illustration of a tabular report illustrating unique Internet user visits to an Internet web site, related sales and a percentage showing the conversion of the visits to sales for stated geographic areas also illustrating stations for media purchases;

FIG. 19 is a schematic illustration of a tabular report illustrating unique Internet user visits to an Internet web site on a daily basis, related sales and a percentage showing the conversion of the visits to sales for stated geographic areas also illustrating stations for media purchases; and

FIG. 20 is a schematic illustration of a graphical representation showing computed and predicted effects of media purchases.

### DETAILED DESCRIPTION OF THE PREFERRED EMBODIMENT

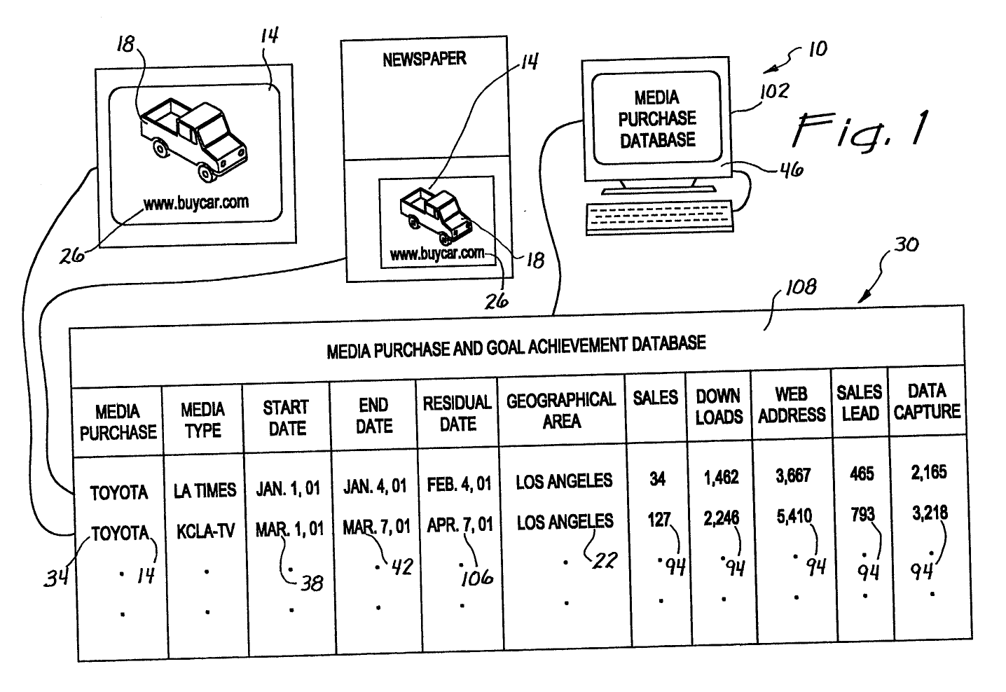

FIGS. 1-5 illustrate a media purchase goal correlation system 10 providing the desired features that may be constructed from the following components. As illustrated in FIG. 1, an advertising media purchase 14 is provided. The media purchase 14 relates to a predetermined subject matter 18 and is placed in movies, video, television, interactive television, radio or print media within a stated geographic area 22. The media purchase 14 includes either an Internet website address 26 or other unique trackable identifier for accessing further information related to the subject matter 18 of the media purchase 14.

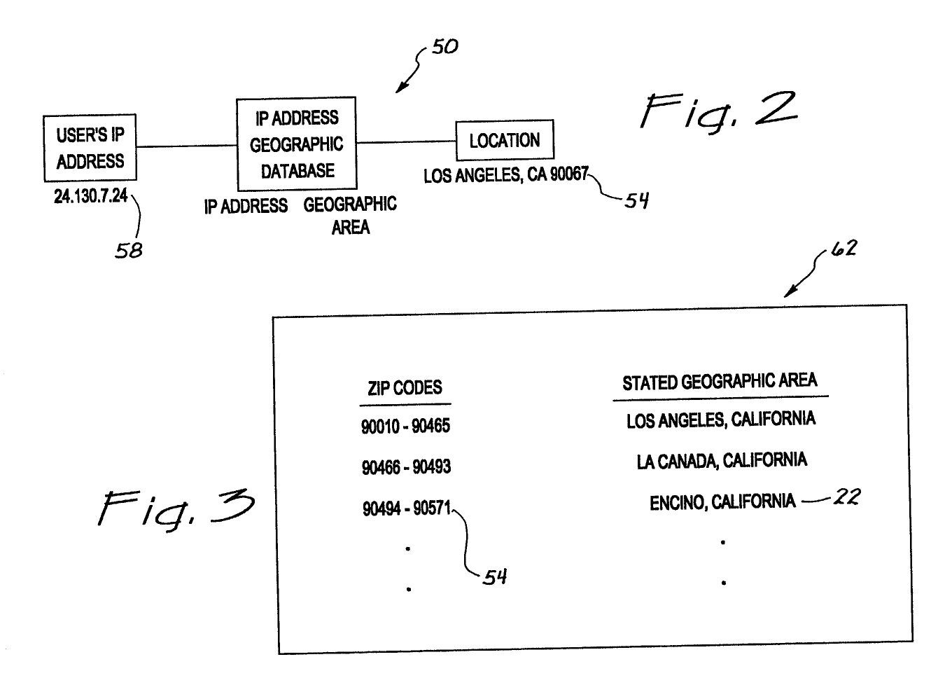

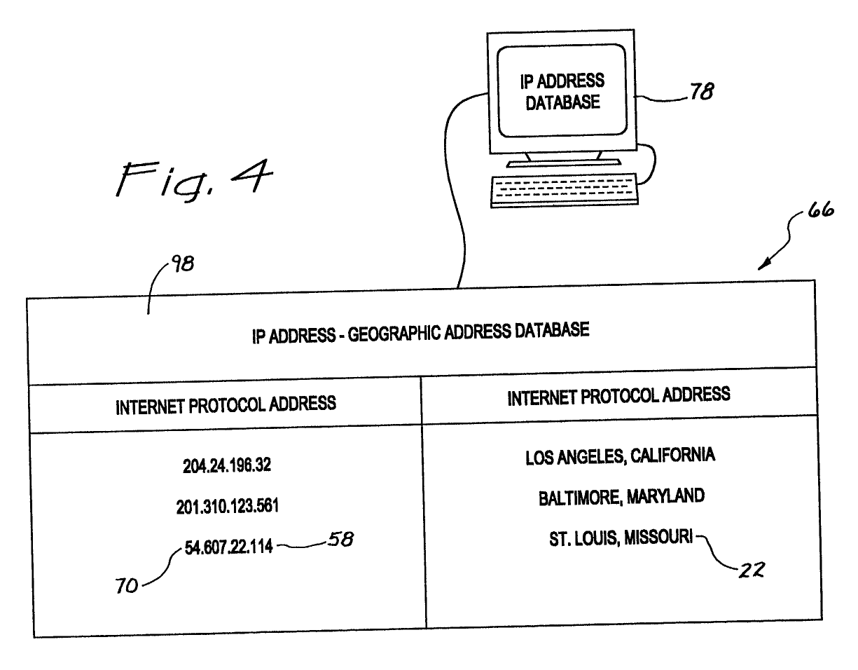

A first database 30 is provided. The first database 30 contains records 34 relating to the start date 38, end date 42, and stated geographic area 22 for a plurality of media purchases 14. Means 46 are provided for inputting and maintaining records 34 in the first database 30. As illustrated in FIG. 2, means 50 are provided for determining the geographic location 54 associated with an Internet Protocol address 58. As illustrated in FIG. 3, means 62 are provided for grouping the geographic locations 54 into uniform stated geographic areas 22.

As illustrated in FIG. 4, a second database 66 is provided. The second database 66 contains records 70 correlating Internet Protocol addresses 58 of Internet users 74 with stated geographic areas 22. Means 78 are provided for inputting and maintaining records 70 in the second database 66. As illustrated in FIG. 5, means 82 are provided for determining the Internet Protocol address 58 of an Internet user 74 accessing the Internet website address 26. Means 86 are provided for tracking the timing 90 of Internet-related goals 94 achieved by the Internet user 74 related to his accessing the Internet website address 26. As illustrated in FIG. 4, means 98 are provided for accessing the second database 66 and assigning a stated geographic area 22 to the user's Internet-related goals 94.

As illustrated in FIG. 1, means 102 are provided for inputting the timing 90 of occurrences of the Internet-related goals 94 and assigned stated geographic area 22 to the first database 30. Means 108 are provided for correlating and reporting the timing 90 of Internet-related goals 94 achieved by the Internet user 74 with the start date 38, end date 42 and a residual period 106 for media purchases 14 within the stated geographic area 22.

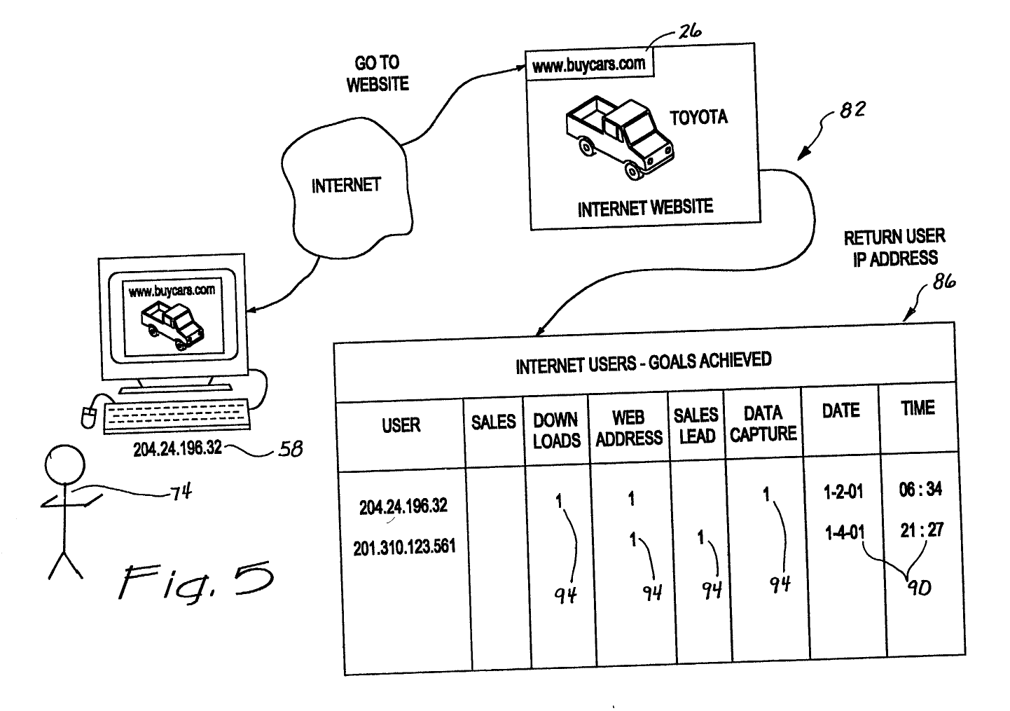

In a variant of the invention, as illustrated in FIG. 6, a media purchase effectiveness report 110 is provided. The effectiveness report 110 includes a media type 114, media name 118, stated geographic area 22 of the media purchase 14, start date 38, end date 42, summary of Internet traffic 122 originating in the stated geographic area 22 between the start 38 and end dates 42, and summary of Internet-related goals 94 achieved for Internet users 74 located within the stated geographic area 22 between the start 38 and end 42 dates and during the residual period 106. The media purchase effectiveness report 110 will permit a media buyer (not shown) to correlate volume of Internet traffic 122 and related goal 94 achievement resulting from a media purchase 14 in a stated geographic area 22.

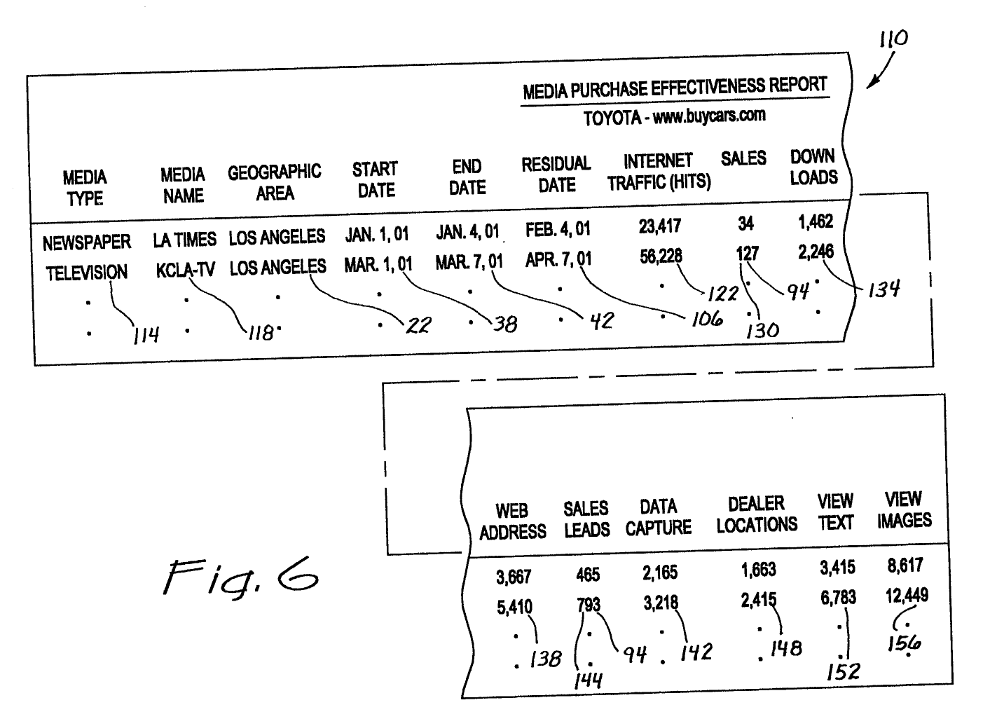

In another variant, as illustrated in FIG. 7, the media effectiveness report 110 is compiled continuously from the start date 38 to the end date 42 of the media purchase 14 and for the residual period 106 and is made available through the Internet 128, whereby a media buyer may evaluate the initial and residual Internet-related impact of any media purchase 14.

In still another variant, as illustrated in FIG. 6, the Internet-related goals 94 comprise sales 130, downloads 134, arrivals at specified web addresses 138, user data capture 142, sales lead generation 144, identification of dealer locations 148, viewing of specific text 152, viewing of specific images 156 and receiving sound transmissions (not shown).

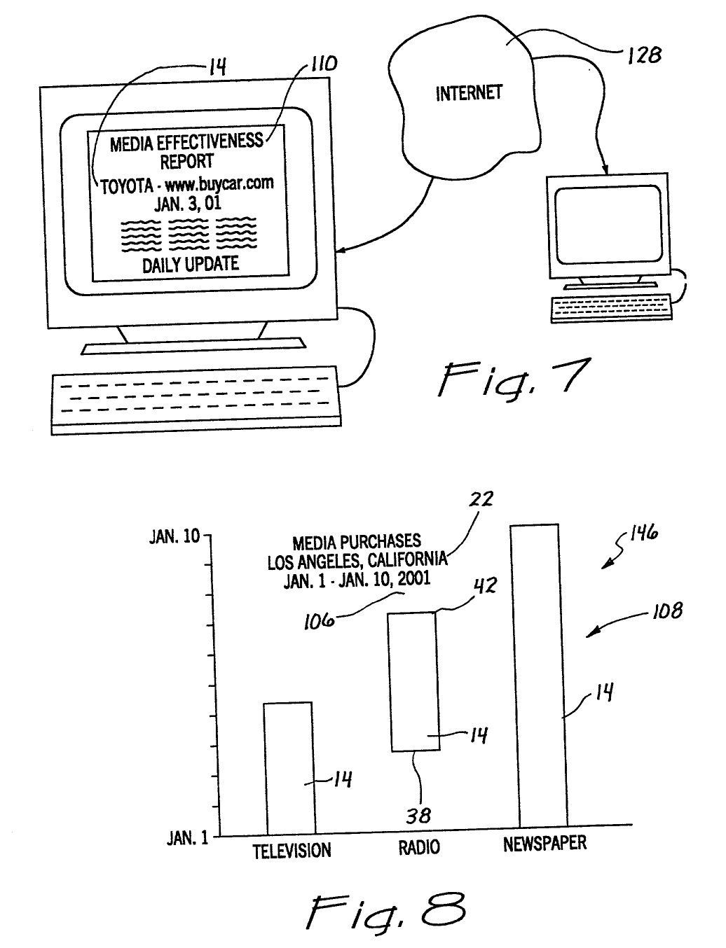

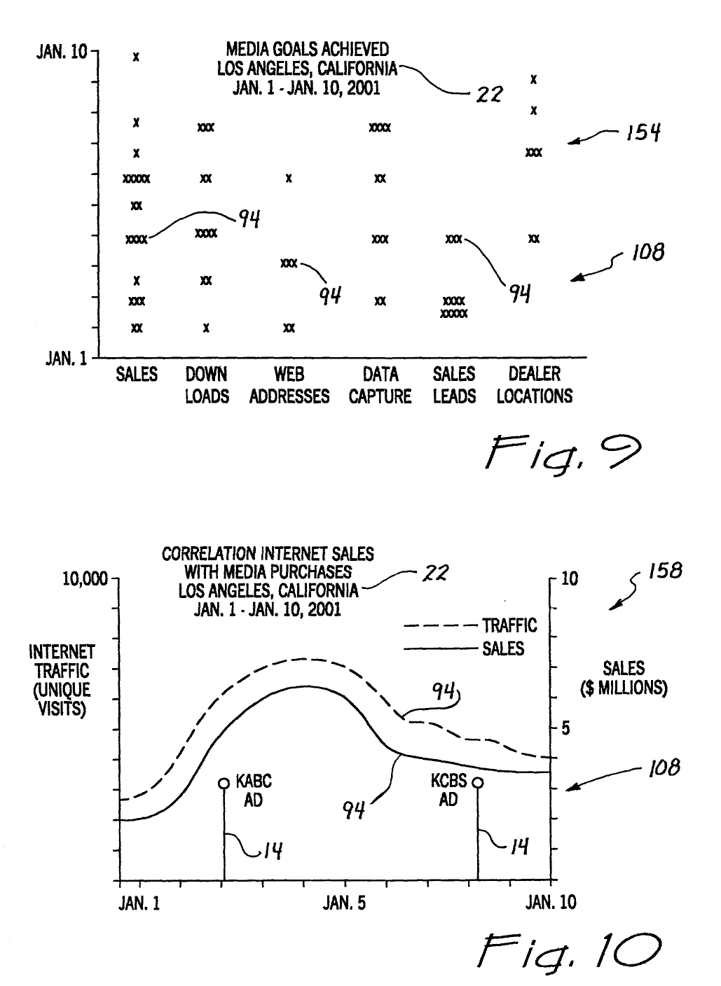

In a further variant of the invention, as illustrated in FIGS. 8-10, the means 108 for correlating and reporting the timing 90 of Internet-related goals 94 achieved by an Internet user 74 with the start date 38, end date 42 and a residual period 106 for media purchases 14 within the stated geographic area 22 includes graphical representations 146 of media purchases 14 for specified periods 150 for stated geographical areas 22, as illustrated in FIG. 8. As illustrated in FIG. 9, it further includes graphical representations 154 of timed occurrences of media goals 94 achieved in the stated geographical areas 22, and graphical representations 158 of the correlation of the timed occurrences of media goals 94 with the media purchase 14 periods for the areas 22, as illustrated in FIG. 10.

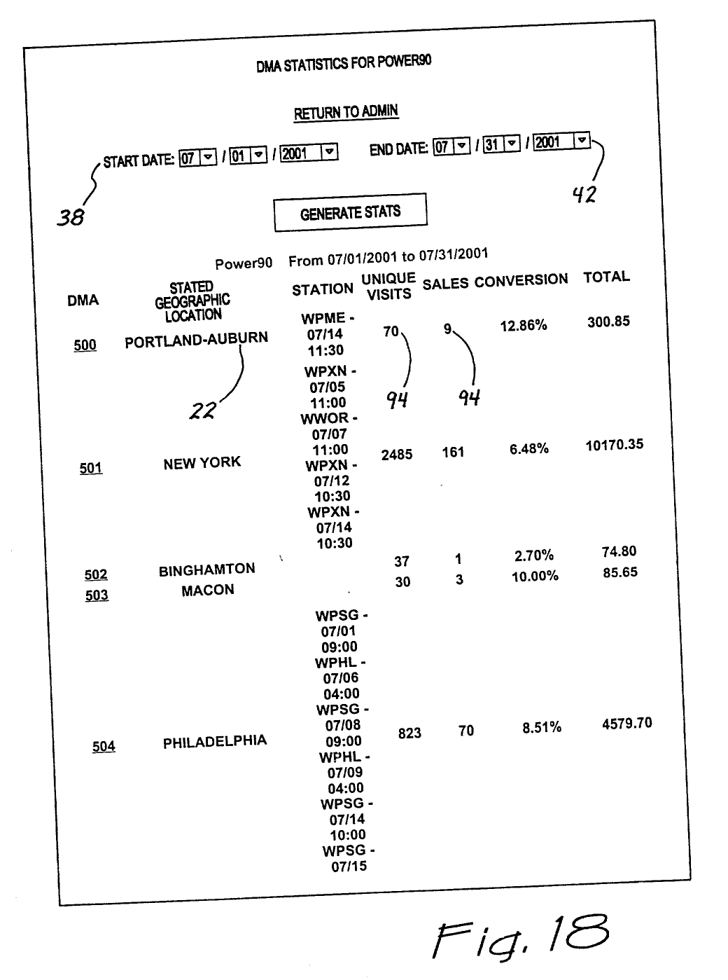

In another variant, as illustrated in FIG. 16, the means 108 for correlating and reporting the timing of Internet-related goals 94 achieved by an Internet user 74 with the start date 38, end date 42 and a residual period 106 for media purchases 14 within the stated geographic area 22 includes pattern recognition systems 162 for analyzing data yielding the graphical representations 146, 154, 158 to produce a media purchase decision 166.

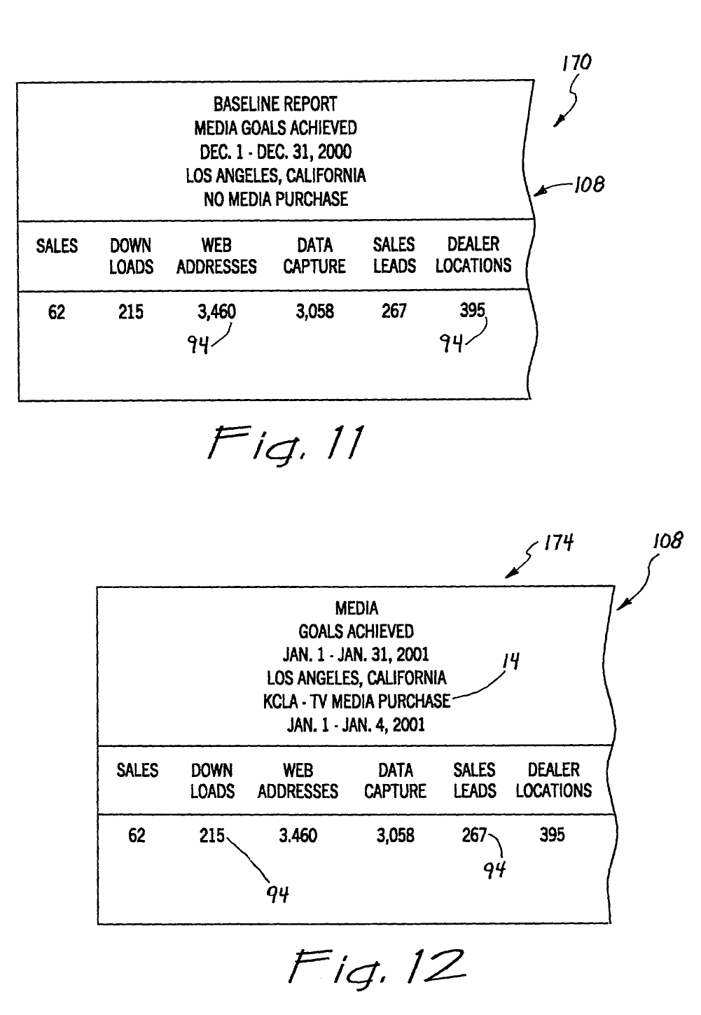

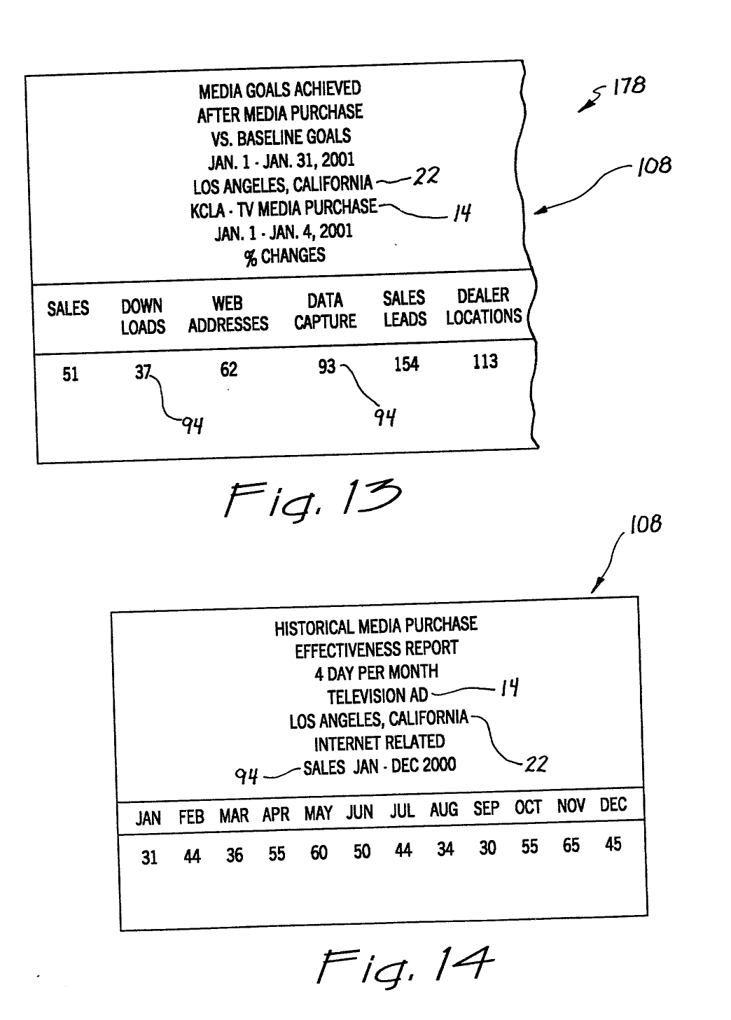

In still another variant, as illustrated in FIGS. 11-13, the means 108 for correlating and reporting the timing of Internet-related goals 94 achieved by an Internet user 74 with the start date 38, end date 42 and a residual period 106 for media purchases 14 within the stated geographic area 22 includes baseline statistical reports 170 of media goals 94 achieved absent media purchases 14, as illustrated in FIG. 11, statistical reports 174 detailing media goals 94 achieved after media purchases 14, as illustrated in FIG. 12, and reports 178 comparing baseline statistics 170 to those resulting from media purchases 14 in stated geographical areas 22, as illustrated in FIG. 13. Such comparisons and predictions may also me shown in graphical form as illustrated in FIG. 20.

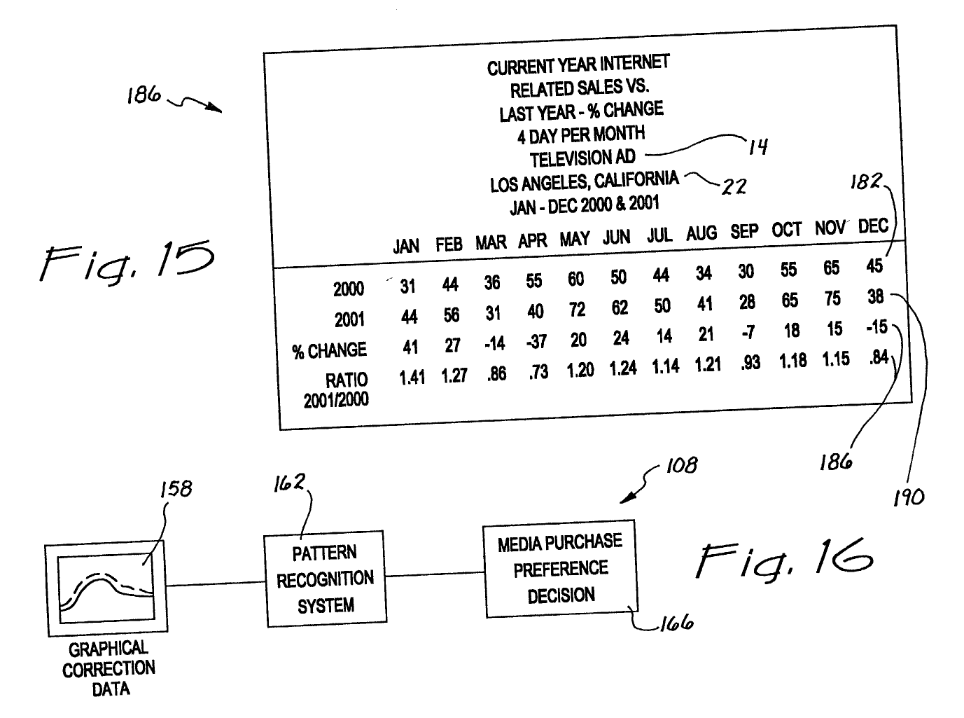

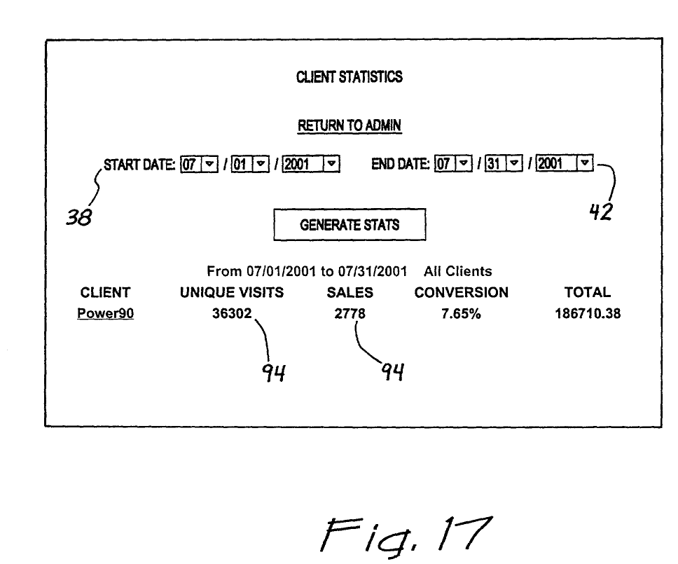

In yet another variant of the invention, as illustrated in FIGS. 14 and 15, the means 108 for correlating and reporting the timing of Internet-related goals 94 achieved by an Internet user 74 with the start date 38, end date 42 and a residual period 106 for media purchases 14 within the stated geographic area 22 includes historical reports 182 detailing effectiveness of media purchases 14 in stated geographical areas 22, as illustrated in FIG. 14, and means 186 for comparing the historical reports 182 to current media goal achievement reports 190 to determine a differential effect of new media purchases 14, as illustrated in FIG. 15. Such comparisons are useful for predicting the effect of future media purchases 14. Such comparisons and predictions may also me shown in graphical form as illustrated in FIG. 20.

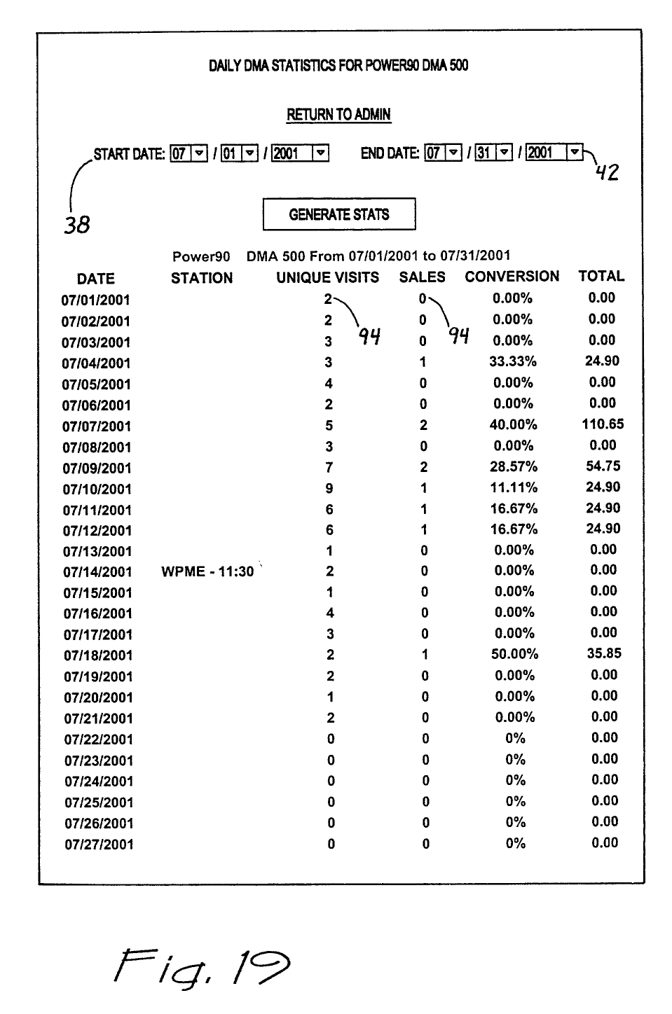

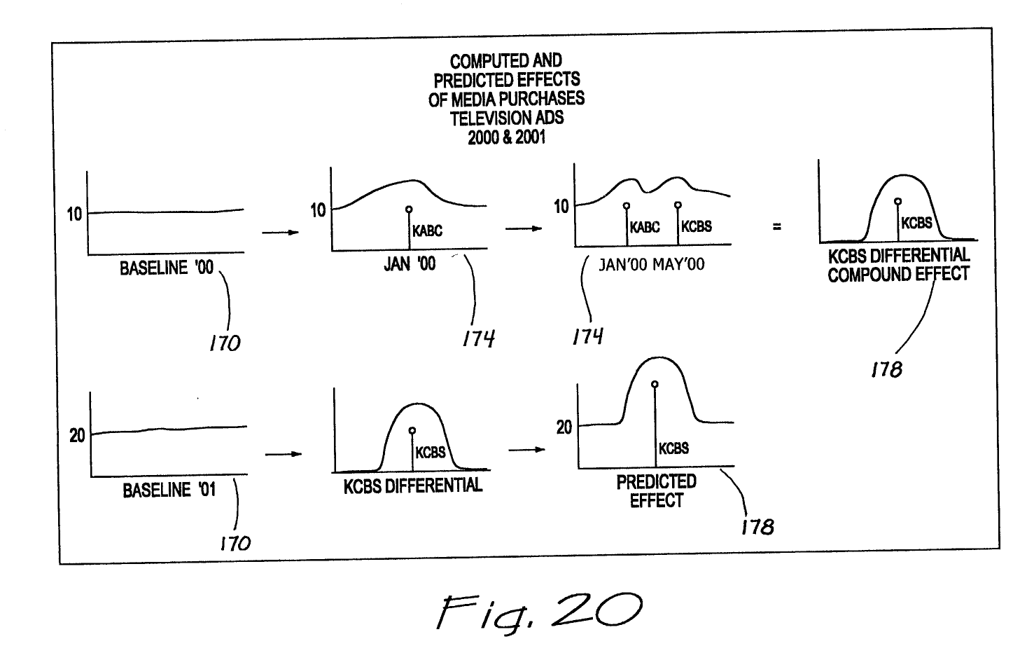

Additional tabular reports, illustrating unique Internet user visits to an Internet web site, related sales and a percentage showing the conversion of the visits to sales for identified media purchasers, in stated geographic areas over various time periods, as illustrated in FIGS. 17-19, are also provided.

The media purchase goal correlation system 10 has been described with reference to particular embodiments. Other modifications and enhancements can be made without departing from the spirit and scope of the claims that follow.

1. A media purchase goal correlation system, comprising:
an advertising media purchase, said media purchase relating to a predetermined subject matter and being placed in either of movies, video, television, interactive television, radio and print media within a stated geographic area;
said media purchase including either of an Internet website address and other unique trackable identifier for accessing further information related to the subject matter of the media purchase;
a first database, said first database containing records relating to the start date, end date, and stated geographic area for a plurality of media purchases;
means for inputting and maintaining records in said first database;
means for determining the geographic location associated with an Internet Protocol address;
means for grouping said geographic locations into uniform stated geographic areas;
a second database, said second database containing records correlating Internet Protocol addresses of Internet users with stated geographic areas;
means for inputting and maintaining records in said second database;
means for determining the Internet Protocol address of an Internet user accessing said Internet website address;
means for tracking the timing of Internet-related goals achieved by said Internet user related to his accessing said Internet website address;
means for accessing said second database and assigning a stated geographic area to said user's Internet-related goals;
means for inputting the timing of occurrences of said Internet-related goals and assigned stated geographic area to said first database; and
means for correlating and reporting the timing of Internet-related goals achieved by said Internet user with the start date, end date and a residual period for media purchases within said stated geographic area.

2. A media purchase goal correlation system as described in claim 1, further comprising:
a media purchase effectiveness report, said effectiveness report comprising a media type, media name, stated geographic area of the media purchase, start date, end date, summary of Internet traffic originating in said stated geographic area between said start and end dates, and summary of Internet-related goals achieved for Internet users located within the stated geographic area between said start and end dates and during a residual period; and
whereby, said media purchase effectiveness report will permit a media buyer to correlate volume of Internet traffic and related goal achievement resulting from a media purchase in a stated geographic area.

3. A media purchase goal correlation system as described in claim 2, wherein said media effectiveness report is compiled continuously from the start date to the end date of the media purchase and for the residual period and is made available through the Internet,
whereby a media buyer may evaluate the initial and residual Internet-related impact of any media purchase.

4. A media purchase goal correlation system as described in claim 1, wherein said Internet-related goals comprise sales, downloads, arrivals at specified web addresses, user data capture, sales lead generation, identification of dealer locations, viewing of specific text, viewing of specific images and receiving sound transmissions.

5. A media purchase goal correlation system as described in claim 1, wherein the means for correlating and reporting the timing of Internet-related goals achieved by an Internet user with the start date, end date and a residual period for media purchases within said stated geographic area further comprises:
graphical representations of media purchases for specified periods for stated geographical areas;
graphical representations of timed occurrences of media goals achieved in said stated geographical areas; and
graphical representations of the correlation of said timed occurrences of media goals with said media purchase periods for said areas.

6. A media purchase goal correlation system as described in claim 5, wherein the means for correlating and reporting the timing of Internet-related goals achieved by an Internet user with the start date, end date and a residual period for media purchases within said stated geographic area further comprises pattern recognition systems for analyzing data yielding said graphical representations to produce a media purchase decision.

7. A media purchase goal correlation system as described in claim 1, wherein the means for correlating and reporting the timing of Internet-related goals achieved by an Internet user with the start date, end date and a residual period for media purchases within said stated geographic area further comprises:
baseline statistical reports of media goals achieved absent media purchases;
statistical reports detailing media goals achieved after media purchases; and
reports comparing baseline statistics to those resulting from media purchases in stated geographical areas.

8. A media purchase goal correlation system as described in claim 1, wherein the means for correlating and reporting the timing of Internet-related goals achieved by an Internet user with the start date, end date and a residual period for media purchases within said stated geographic area further comprises:
historical reports detailing effectiveness of media purchases in stated geographical areas; and
means for comparing said historical reports to current media goal achievement reports to determine differential effect of new media purchases; and
whereby, such comparisons are useful for predicting the effect of future media purchases.
